(19) United States
(12) Patent Application Publication
(10) Pub. No.: US 2007/0278430 A1
(43) Pub. Date: Dec. 6, 2007

(54) Structure for Ray Source Apparatus of Radiotherapy Device

(76) Inventor: Yanxiong Qiu, Shenzhen (CN)

Correspondence Address: GLOBAL IP SERVICES, 7285 W. Eagle Court, Winton, CA, 95388, US

(21) Appl. No.: 11/696,293

(22) Filed: Apr. 4, 2007

(30) Foreign Application Priority Data
Apr. 13, 2006 (CN) 200620013188.4

(51) Int. Cl. G21F 5/00

(52) U.S. Cl. 250/506.1

(57) ABSTRACT

A structure for ray source apparatus of radiotherapy device, which comprising a shielding body, a ray source table and a collimation body, wherein all the shielding body, ray source table and collimation body are shaped as a spherical segment, while the shielding body is installed on the outside of the ray source table, and the collimation body is installed inside; the ray source table is homocentric with the collimation body, but un-homocentric with the shielding body. With this structure, the whole radiotherapy device is simplify in structure, low price, and saving in shielding materials, while ensuring the shielding efficiency.

### CROSS REFERENCE TO THE RELATED PATENT APPLICATION

This application claims the priority right of the Chinese patent application No. 200620013188.4, the filing date of Apr. 13, 2006.

### FIELD OF THE INVENTION

The present invention relates to a radiotherapy device, particularly, relates to a structure for ray source apparatus of radiotherapy device.

### BACKGROUND OF THE INVENTION

Ordinarily, in the structure of traditional radiotherapy device, the shielding body, ray source table and collimation body are homocentrically arranged, as a result, the thickness of the shielding body that covered on the outside of the whole ray source table is the same, whenever the device is in using or standing by. This kind of structure makes the device applies much more shielding materials, thus makes the device much heavy and more expensive. Especially when the device is applying “C” shaped opening unilateral supporting kickstand, the whole device will not so stable due to mass heavy and departure of barycenter from the unilateral supporting kickstand.

### SUMMARY OF THE INVENTION

One objection of the present invention is to provide a structure for ray source apparatus of radiotherapy device, which is simplify in structure, low price, and saving in shielding materials.

The technical solution of the present invention is, provides a structure for ray source apparatus of radiotherapy device, which comprising a shielding body, a ray source table and a collimation body, wherein all the shielding body, ray source table and collimation body are shaped as a spherical segment, while the shielding body is installed on the outside of the ray source table, and the collimation body is installed inside; the ray source table is homocentric with the collimation body, but un-homocentric with the shielding body.

In the present invention, as the ray source table is homocentric with the collimation body, but un-homocentric with the shielding body, the thickness of the shielding body that installed on the outside of the whole ray source table is not uniform. When the radiotherapy device is standing by, by turning the ray source table, the ray source inside the table then is placed inside the thickest portion of the shielding body. Especially when the radiotherapy device is applying “C” shaped opening unilateral supporting kickstand, as for the eccentric structure, the barycenter of the ray source apparatus will lean to the unilateral supporting kickstand, therefore stabilize the whole device; at the same time, with this structure, the whole radiotherapy device is simplify in structure, low price, and saving in shielding materials, while ensuring the shielding efficiency.

### BRIEF DESCRIPTION OF THE DRAWINGS

FIG. 1 is the schematic view of the ray source apparatus in the present invention.

### DETAILED DESCRIPTION OF THE PREFERRED EMBODIMENT

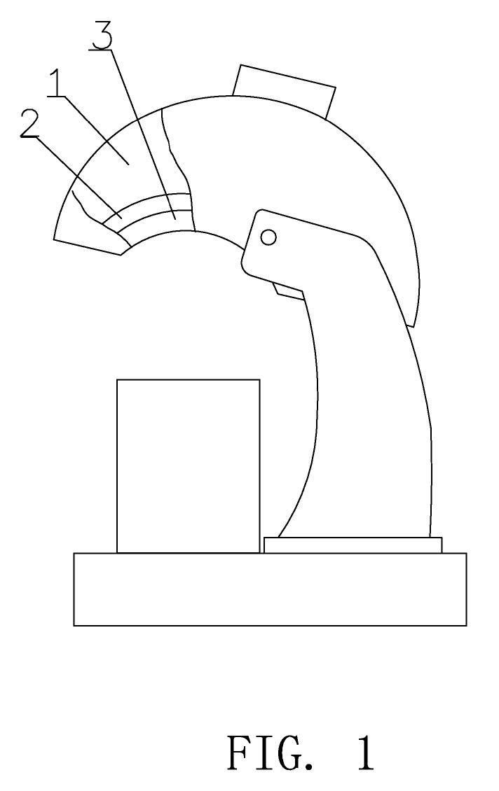

As shown in FIG. 1, the structure for ray source apparatus of radiotherapy device of the present invention comprising a shielding body 1, a ray source table 2, and a collimation body 3, wherein all the shielding body 1, ray source table 2 and collimation body 3 are shaped as a spherical segment, while the shielding body 1 is installed on the outside of the ray source table 2, and the collimation body 3 is installed inside; the ray source table 2 is homocentric with the collimation body 3, but un-homocentric with the shielding body 1.

As the structure for ray source apparatus of radiotherapy device applies the above-mentioned technical solution, the ray source table 2 is homocentric with the collimation body 3, but un-homocentric with the shielding body 1, so, the thickness of the shielding body 1 that installed on the outside of the whole ray source table 2 is not uniform. When the radiotherapy device is standing by, by turning the ray source table 2, the ray source inside the table 2 then is placed inside the thickest portion of the shielding body 1. Especially when the radiotherapy device is applying “C” shaped opening unilateral supporting kickstand, as for the eccentric structure, the barycenter of the ray source apparatus will lean to the unilateral supporting kickstand, therefore stabilize the whole device; at the same time, with this structure, the whole radiotherapy device is simplify in structure, low price, and saving in shielding materials, while ensuring the shielding efficiency.

Throughout the specification the aim has been to describe the preferred embodiment of the present invention without limiting the invention to any one embodiment or specific collection of features. Persons skilled in the relevant art may realize variations from the specific embodiment that will nonetheless fall within the scope of the invention.

What is claimed is:

1. A structure for ray source apparatus of radiotherapy device comprising a shielding body, a ray source table and a collimation body, wherein said shielding body, ray source table and collimation body are shaped as spherical segment; the shielding body is installed on the outside of the ray source table, and the collimation body is installed inside; the ray source table is homocentric with the collimation body, but un-homocentric with the shielding body.
